(19) United States
(12) Patent Application Publication
(10) Pub. No.: US 2014/0102259 A1
(43) Pub. Date: Apr. 17, 2014

(54) Carabiner Bottle Opener

(71) Applicants: Zachary Albrecht, Fort Lauderdale, FL (US); Cristos Ifantides, New York, NY (US); Colby Siljestrom, Gainesville, FL (US); Brenton Powell, Sarasota, FL (US)

(72) Inventors: Zachary Albrecht, Fort Lauderdale, FL (US); Cristos Ifantides, New York, NY (US); Colby Siljestrom, Gainesville, FL (US); Brenton Powell, Sarasota, FL (US)

(21) Appl. No.: 14/053,687

(22) Filed: Oct. 15, 2013

Related U.S. Application Data
(60) Provisional application No. 61/714,256, filed on Oct. 16, 2012.

(51) Int. Cl. B67B 7/16

(52) U.S. Cl. CPC B67B 7/16
USPC 81/3.09; 53/492

(57) ABSTRACT

A bottle opener comprising a carabiner frame with an inwardly opening pivoting gate on a first side of the frame and an appendage comprising an area engagable with an underside of a bottle cap. The appendage protrudes into a space within the carabiner frame from a point on an interior of a second side of the frame opposite the first side. When the gate is opened, a free end of the gate fits under the appendage.

### CROSS-REFERENCES TO RELATED APPLICATIONS

This patent application claims the benefit of provisional patent application Ser. No. 61714256, filed Oct. 16, 2012, hereby incorporated by reference.

### FIELD OF THE INVENTION

The invention relates generally to bottle openers and specifically to open a bottle with a carabiner while retaining the shape/full function of a traditional carabiner.

### BACKGROUND OF THE INVENTION

Description of Problem(s) Solved by Invention:

Current carabiners that are able to open bottles fail to retain the original feel, shape, and/or design of traditional carabiners. Our unique design retains the full function of a traditional carabiner (Attached items can traverse the entire frame).

How the Invention is an Improvement Over Existing Technology:

This invention retains the shape, relative feel, parts, and inside spatial area of non-bottle opening carabiners. It is better than anything that exists because it looks and feels almost identical to a typical carabiner with the exception of one additional part attached to the interior frame of the carabiner (the appendage). As a result, the shape and functionality of the carabiner remains consistent with the traditional design, and has the added benefit of opening bottles.

Groups of People and/or Businesses That Would Use the Invention: Keychain users, beverage drinkers, bartenders, and companies who distribute promotional swag.

Benefits to Users of Invention:

Users will be able to have a carabiner that retains the main function- allowing items to be hooked onto it. Our design allows items normally clipped to carabiners to traverse the entire frame. It also allows users to open bottles with a carabiner.

The device and method of the present invention can comprise, consist of, or consist essentially of the essential elements and limitations of the invention described herein, as well as any additional or optional components or limitations described herein or otherwise useful in systems and methods of the general type as described herein. All combinations of method or process steps as used herein can be performed in any order, unless otherwise specified or clearly implied to the contrary by the context in which the referenced combination is made.

### SUMMARY OF THE INVENTION

The carabiner bottle opener is a product that allows for opening of both screw top and non-screw top bottles while retaining the shape, relative feel, parts, and inside spatial area of traditional non-bottle opening carabiners. The bottle opener appendage connects to the main frame of the carabiner only on one side of the frame, allowing for keys or other items that are clipped into the carabiner to traverse the entire frame of the carabiner.

The bottle opener comprises a carabiner frame with an inwardly opening pivoting gate on a first side of the frame and an appendage comprising an end area engagable with an underside of a bottle cap. The appendage is located on the carabiner frame from a point on an interior of a second side of the frame opposite the first side and protrudes into a space within the frame. When the gate is opened, a free end of the gate fits under the appendage.

All references to singular characteristics or limitations of the present invention shall include the corresponding plural characteristic or limitation, and vice versa, unless otherwise specified or clearly implied to the contrary by the context in which the reference is made.

### DRAWING FIGURES

FIG. 1 is an illustration of the invention in an opened and closed position.

FIG. 2 is an illustration of the invention with the gate closed.

FIG. 3 represents a side view of the invention engaging a bottle cap.

FIG. 4 represents a top view of the invention engaging a bottle cap.

### DETAILED DESCRIPTION OF THE INVENTION

Identification of Parts/Components of Invention:

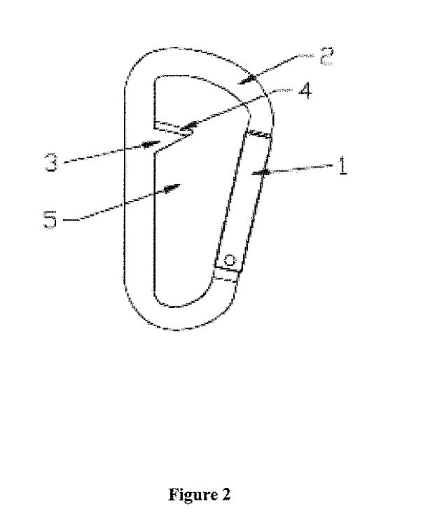

Please reference FIG. 2

Reference Numeral—Descriptive Name for Part

1—pivoting gate

2—carabiner frame

3—Bottle opener appendage

4—Engaging area of appendage

5—Represents the open area within the carabiner

Description of the Parts of the Invention:

FIG. 2:

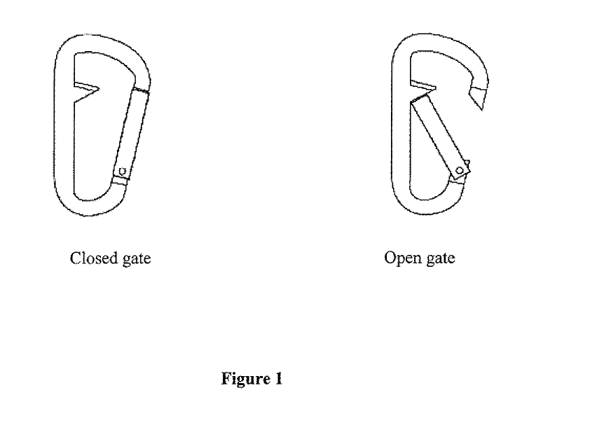

Part 1 is the pivoting gate that is normally found on carabiners. It opens inward towards the open space labeled “5” (the gate can be seen in the open position in FIG. 1). The pivoting gate follows similar traditional carabiner designs in that it cannot be opened outward. This forms a locking mechanism. Part 2 is the main carabiner frame. Part 3 is the appendage that engages the underside of a bottle cap. Part 4 is illustrating that the appendage can be grooved, textured, or smooth to allow for better engagement with the bottle cap. Part 5 represents the internal open space of the carabiner.

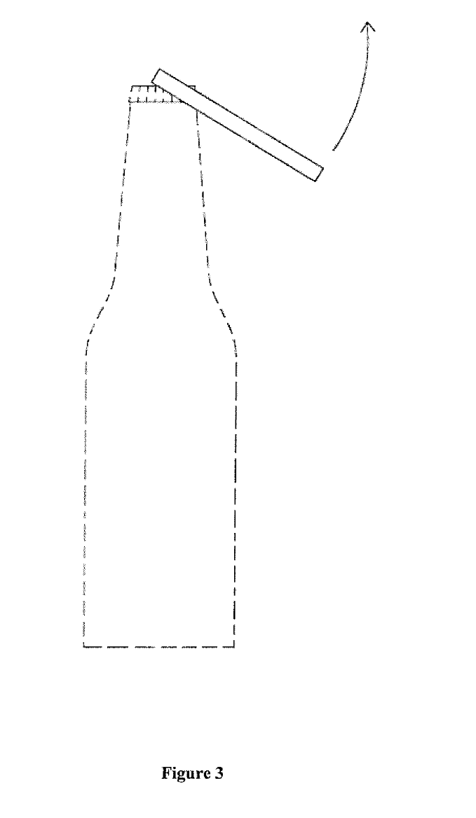

FIG. 3:

The arrow represents the upward force used to leverage the cap off of the bottle. The frame of the carabiner (part 2 from FIG. 2) is placed on top of the bottle cap. The appendage (part 3 and 4 of FIG. 2) is placed underneath the bottle cap. This creates a fulcrum that dislodges the bottle cap once upward force is applied. This bottle opener retains a traditional upward motion that is shared with many common bottle openers (unlike other carabiner bottle openers in which downward force is applied to dislodge a bottle cap).

Description of Overall Structure of Invention:

The overall structure of the invention is very reminiscent of currently available, mass produced carabiners. This invention mimics a traditional carabiner frame and pivoting gate. What we have added is the appendage that can aid in opening bottle caps. The added appendage is designed to be minimal and should not limit normal use of the carabiner very much. There are multiple designs possible with alternate dimensions of the appendage. The main goal of the appendage is to only be connected to the main frame of the carabiner in such a way as to allow for items to traverse the entire length of the carabiner frame (example: keys on a key ring rotating around the complete carabiner frame).

Relationship Between the Parts of the Invention:

Please refer to FIG. 2. Part 1 is a pivoting gate that can be pushed inward into the space labeled part 5. Part 1 is hinged to the main frame (part 2) which allows for movement of part 1 while it remains attached to the main frame at a pivot point. There is a biasing means, such as a spring, that allows for part I to return to its closed position once inward directed force is removed from part 1.

The space between part 2 and 3&4 is the open area where a bottle cap would engage the bottle opener.

Description of How the Invention Operates/Functions:

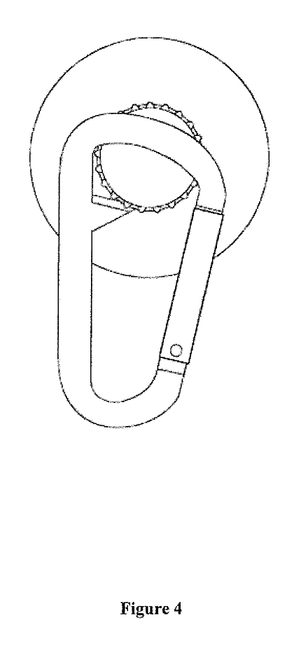

The operator will tilt the carabiner in such a way that the angle in which the carabiner approaches the bottle will allow for the frame of the carabiner to rest on top of the bottle cap while allowing for the appendage to be placed underneath the bottle cap. Once the operator has ensured that the frame is resting on top of the bottle cap and the appendage is engaging the bottom of the bottle cap, the operator will apply upward force to the carabiner frame. This allows the frame of the carabiner that is on top of the bottle cap to act as a fulcrum. The appendage will transfer the upward force to the cap, dislodging the cap from the bottle. Please reference FIGS. 3 and 4 for a graphical representation of how the carabiner will engage the bottle cap.

In addition, our invention can operate as a traditional carabiner. It can be hooked on to things such as a belt loop or purse and rotate freely similar to a traditional carabiner. Alternatively, things may be clipped into the carabiner such as keys on a ring, reusable water bottles, key chains, etc.

Unique Features of Invention:

Some devices alter the interior angles of the carabiner or have the bottle opener on the outside of the frame. This causes the frame to have an unfamiliar shape and unsmooth edges along the external border.

Other designs have the bottle opener on the inside area of the carabiner, but these designs segment the inside space of the carabiner, creating multiple, non-continuous spaces. These designs do not allow keys or other items to traverse the entire frame of the carabiner.

Traditional carabiners allow items to traverse the entire frame of the carabiner. Similarly, traditional carabiners can be rotated around a belt loop without issues while items such as key rings are attached to the carabiner. Our design can also accomplish this.

We believe these previous designs decrease the functionality and feel of the carabiner.

How to Make the Invention:

A person would make this very similarly to how current mass produced carabiners are made. It could be made using common methods such as mold casting or machining tools to create the different parts. Once the pieces are created, they could be combined the same way traditional carabiners are made.

A person could also create the appendage and carabiner frame separately. The separate elements could then be brought together and connected via a screw, locking mechanism, adhesive material, or other means.

Finally, the invention could be made by creating an “appendage add-on” that could be attached to already existing carabiners, adding a bottle opening feature to a traditionally produced carabiner.

The carabiner could be made of any type of material. For example, it could be made of something common like stainless steel or aluminum, or it could be something less common like carbon fiber or titanium. It need not be metallic. The shape of the appendage can also vary. It can have a different height, width, thickness, or shape than is pictured in the figures.

The foregoing descriptions of specific embodiments of the present invention have been presented for purposes of illustration and description. They are not intended to be exhaustive or to limit the invention to the precise forms disclosed, and obviously many modifications and variations are possible in light of the above teachings. It will be understood that the invention is intended to cover alternatives, modifications and equivalents. The embodiments were chosen and described in order to best explain the principles of the invention and its practical application, to thereby enable others skilled in the art to best utilize the invention and various embodiments with various modifications as are suited to the particular use contemplated. It is therefore to be understood that within the scope of the appended claims, the invention may be practiced otherwise than as specifically described herein.

We claim:

1. A bottle opener comprising:
a) a carabiner frame with an inwardly opening pivoting gate on a first side of the frame, and
b) an appendage comprising an area engagable with an underside of a bottle cap, the appendage protruding into a space within the carabiner frame from a point on an interior of a second side of the frame opposite the first side, such that, when the gate is opened, a free end of the gate fits under the appendage.

2. The bottle opener of claim 1 wherein the finish of the exterior of the appendage is selected from the group consisting of grooved, textured, and smooth.

3. The bottle opener of claim 1 wherein the carabiner is functional as carabiner.

4. The bottle opener of claim 1 wherein the appendage is of such dimensions that a standard key ring placed on the frame of the carabiner is able to rotate freely around the entire frame.

5. The bottle opener of claim 1 wherein the appendage is a standalone aftermarket kit that is attachable to the frame.

6. The bottle opener of claim 1 wherein the frame and the appendage are formed from a material selected from the group consisting of stainless steel, aluminum, carbon fiber and titanium.

7. A method of using the bottle opener of claim 1 comprising:
a) placing a first end of the opener on a top of a bottle cap engaged on a bottle;
b) placing the appendage underneath the bottle cap;
c) applying an upward motion to a second end of the opener, the second end opposite the first end, until the bottle cap released from the bottle.
